(19) United States
(12) Patent Application Publication
(10) Pub. No.: US 2024/0042494 A1
(43) Pub. Date: Feb. 8, 2024

(54) Pressure-Washing Vehicle Device

(71) Applicant: Cleveland Faddis, Birmingham, AL (US)

(72) Inventor: Cleveland Faddis, Birmingham, AL (US)

(21) Appl. No.: 17/881,364

(22) Filed: Aug. 4, 2022

(51) Int. Cl. B08B 3/02; B08B 13/00; B05B 13/00; B05B 15/68; B05B 3/02

(52) U.S. Cl. CPC B08B 3/024; B08B 13/00; B05B 13/005; B05B 15/68; B05B 3/02

(57) ABSTRACT

A pressure-washing vehicle device for pressure-washing a support surface while operating a vehicle on the same support surface includes a vehicle with a lift arm pivotably coupled to and extending forwardly from the vehicle. The lift arm pivotably raises and lowers a spray deck with a top wall and a perimeter wall circumscribing and extending away from the top wall. A spray arm is positioned within the perimeter wall of the spray deck and is rotatably coupled to the top wall of the spray deck. The spray arm is configured for dispensing a flow of a fluid at force against a support surface, thereby removing a debris from the support surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pressure-washing devices and more particularly pertains to a new pressure-washing device for pressure-washing a support surface while operating a vehicle on the same support surface.

### (2) Description of Related Art Including Information Disclosed Under 37 CFR 1.97 and 1.98

The prior art relates to pressure-washing devices which utilize a vehicle driven by the user to pressure-wash the surface on which the vehicle is driving. The prior art discloses vehicles equipped with enclosed pressure-washing elements, including one device that mounts both an enclosed rotating pressure-washing element and an unenclosed linear pressure-washing element at the front of a zero-run radius (ZRT) vehicle. Another device mounts an enclosed rotating pressure-washing element below a carriage of the vehicle, which is not a ZRT vehicle. However, the prior art does not disclose a device which repositions the enclosed pressure-washing element for improved maneuverability before and after the pressure-washing task.

### BRIEF SUMMARY OF THE INVENTION

An embodiment of the disclosure meets the needs presented above by generally comprising a vehicle with a lift arm pivotably coupled to and extending forwardly from the vehicle. The lift arm pivotably raises and lowers a spray deck with a top wall and a perimeter wall circumscribing and extending away from the top wall. A spray arm is positioned within the perimeter wall of the spray deck and is rotatably coupled to the top wall of the spray deck. The spray arm is configured for dispensing a flow of a fluid at force against a support surface, thereby removing a debris from the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a pressure-washing vehicle device according to an embodiment of the disclosure.

FIG. 2 is an opposite side view of an embodiment of the disclosure.

FIG. 3 is a top view of an embodiment of the disclosure.

FIG. 4 is an in-use view of an embodiment of the disclosure.

### DETAILED DESCRIPTION OF THE INVENTION

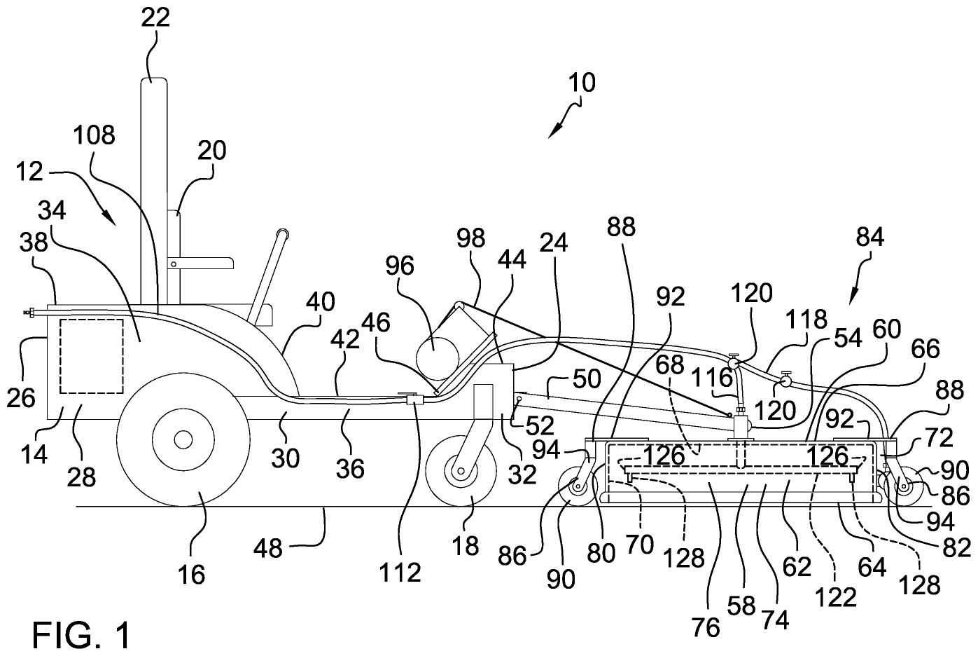

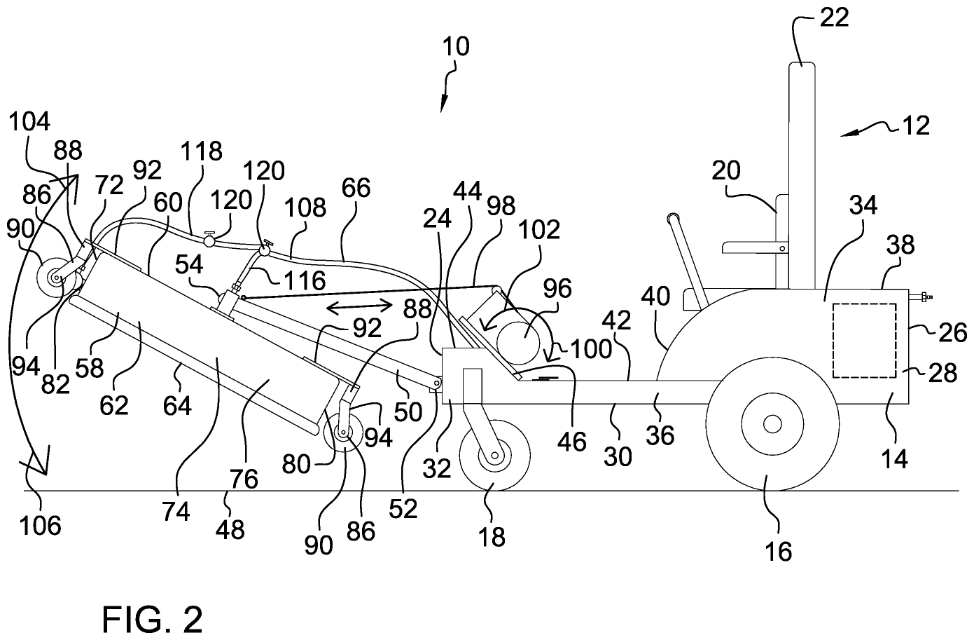

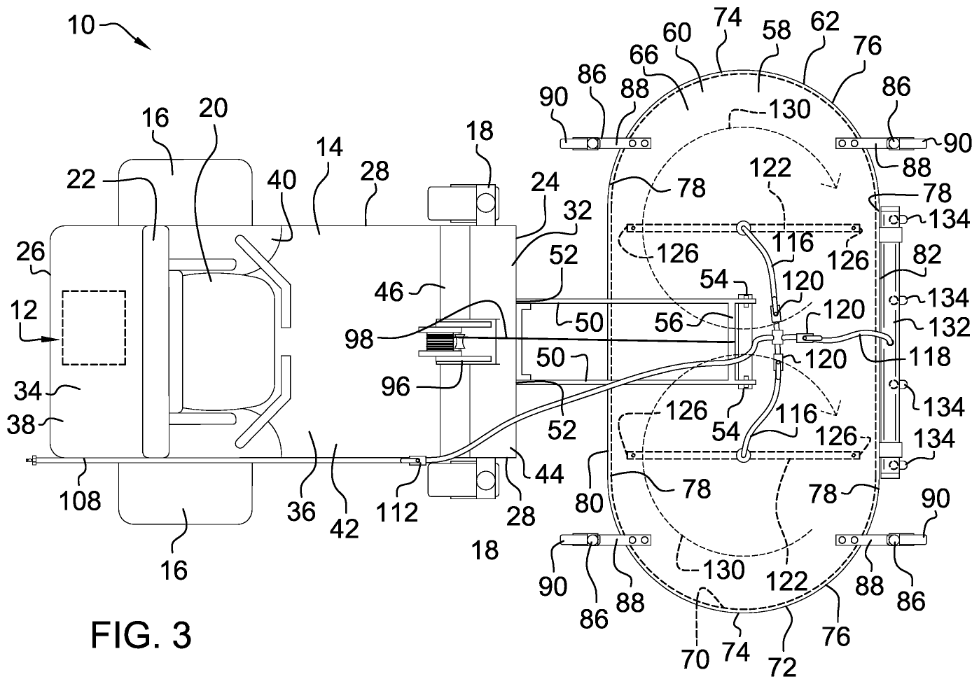

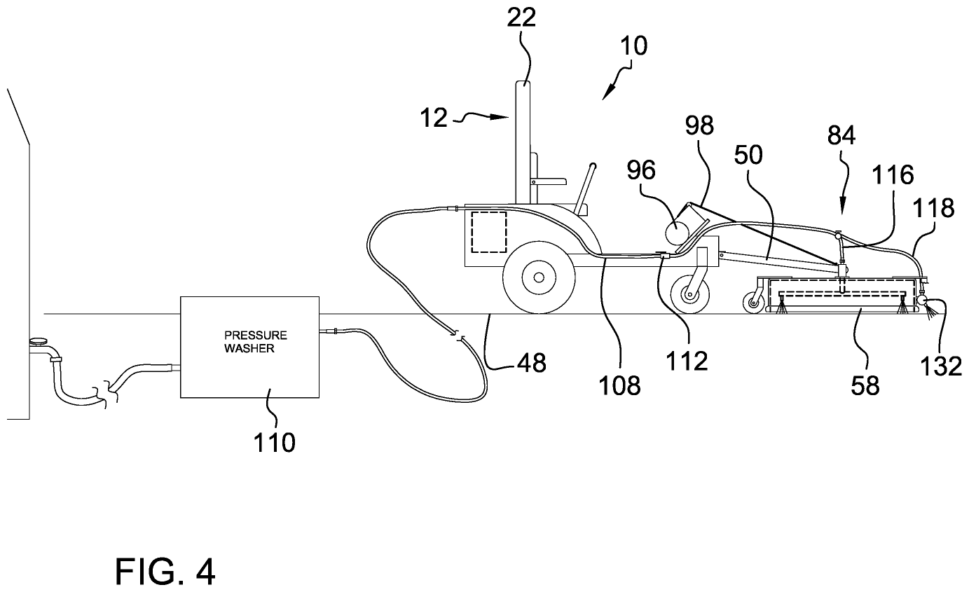

With reference now to the drawings, and in particular to FIGS. 1 through 4 thereof, a new pressure-washing device embodying the principles and concepts of an embodiment of the disclosure and generally designated by the reference numeral 10 will be described.

As best illustrated in FIGS. 1 through 4, the pressure-washing vehicle device 10 generally comprises a vehicle 12, wherein the vehicle 12 has a body 14, a pair of drive wheels 16, a pair of casters 18, a chair 20, and a roll bar 22. The body 14 of the vehicle 12 has a front end 24 and a back end 26, and a pair of lateral sides 28 extending between the front end 24 of the body 14 and the back end 26 of the body 14. The body 14 also has a bottom side 30 extending between the front end 24 of the body 14 and the back end 26 of the body 14 and between the lateral sides 28 of the body 14. The body 14 has a front section 32 adjacent to the front end 24 of the body 14, a back section 34 adjacent to the back end 26 of the body 14, and a platform section 36 between the front section 32 and the back section 34.

The back section 34 has a top surface 38 and a front surface 40, the top surface 38 of the back section 34 opposing the bottom side 30 of the body 14. The front surface 40 of the back section 34 is convex and extending from the platform section 36 to the top surface 38 of the back section 34. The platform section 36 has a top surface 42 which opposes the bottom side 30 of the body 14. The platform section 36 has a height between the top surface 42 of the platform section 36 and the bottom side 30 of the body 14 less than a height of the back section 34 between the top surface 38 of the back section 34 and the bottom side 30 of the body 14. The front section 32 has a top surface 44 which opposes the bottom side 30 of the body 14. The front section 32 has a height between the top surface 44 of the front section 32 and the bottom side 30 of the body 14 greater than the height of the platform section 36 and less than the height of the back section 34. The front section 32 has a back surface 46 which extends from the top surface 44 of the front section 32 to the platform section 36.

The pair of drive wheels 16 is rotationally coupled to the body 14 and is rotatable about a drive axis that is positioned away from the bottom side 30 of the body 14 and perpendicular to each lateral side 28 of the body 14. Each drive wheel 16 is positioned proximate an associated lateral side 28 of the body 14. The pair of drive wheels 16 is configured for moving the vehicle 12 over a support surface 48. The pair of casters 18 is coupled to the front section 32 of the body 14 on the lateral sides 28 of the body 14, extending away from the bottom side 30 of the body 14. The pair of casters 18 is also configured for supporting the vehicle 12 on the support surface 48.

The chair 20 is positioned proximate the top surface 38 of the back section 34 of the body 14 and the front surface 40 of the back section 34 of the body 14. The chair 20 faces toward the front end 24 of the body 14. The roll bar 22 is coupled to the top surface 38 of the back section 34 of the body 14 proximate the chair 20. The roll bar 22 arcs away from the body 14 between the lateral sides 28 of the body 14.

Each of a pair of lift arms 50 has a first end 52 and a second end 54. The first end 52 of each lift arm 50 is pivotably coupled to the front end 24 of the body 14 of the vehicle 12, each lift arm 50 is pivotable such that an elevation of the second end 54 of each pair of lift arms 50 relative to the body 14 of the vehicle 12 is adjustable. A crossbar 56 extends between and couples the pair of lift arms 50 proximate each second end 54 of each lift arm 50.

A spray deck 58 has a top wall 60 and a perimeter wall 62 circumscribing and extending away from the top wall 60 to a rim end 64 of the perimeter wall 62. The top wall 60 has an outer surface 66 facing away from the perimeter wall 62 and an inner surface 68 opposing the outer surface 66 of the top wall 60. The perimeter wall 62 has an inner surface 70 facing within the perimeter wall 62 and an outer surface 72 opposing the inner surface 70 of the perimeter wall 62. The top wall 60 is elongated between a pair of lateral ends 74. The top wall 60 also has a pair of lateral edges 76 which each extend through an associated lateral end 74 of the top wall 60. Each lateral edge 76 is arcuate and has a pair of ends 78. The top wall 60 has a first edge 80 and a second edge 82 opposing the first edge 80. Each of the first edge 80 and the second edge 82 extend between the pair of lateral edges 76 and is parallel to a central longitudinal axis of the top wall 60.

The outer surface 66 of the top wall 60 is pivotably coupled to the second end 54 of each lift arm 50 such that the second ends 54 of the pair of lift arms 50 are aligned with a central longitudinal axis of the top wall 60. The spray deck 58 is configured to be positionable in a spraying position 84 wherein the perimeter wall 62 is positioned between the top wall 60 and the support surface 48 and the first edge 80 is closer to the vehicle 12 than the second edge 82.

A plurality of spray deck casters 86 is coupled to the spray deck 58 and is configured for movably supporting the spray deck 58 on the support surface 48 when the spray deck 58 is in the spraying position 84. Each spray deck caster 86 includes a caster bracket 88 and a caster wheel 90. A first portion 92 of each caster bracket 88 is coupled to the outer surface 66 of the top wall 60 of the spray deck 58 and extends away from the outer surface 72 of the perimeter wall 62 perpendicular to the central longitudinal axis of the top wall 60. A second portion 94 of each caster bracket 88 extends away from the inner surface 68 of the top wall 60. Each caster wheel 90 is coupled to an associated second portion 94 of each caster bracket 88 and is configured for movably supporting the spray deck 58 on the support surface 48 when the spray deck 58 is in the spraying position 84. Each spray deck caster 86 is positioned such that the first portion 92 of each caster bracket 88 extends across an associated lateral edge 76 of the top wall 60 proximate a respective end 78 of each pair of ends 78 of each lateral edge 76. The plurality of spray deck casters 86 is equidistant from a center of the top wall 60.

A winch 96 is coupled to the back surface 46 of the front section 32 of the body 14 of the vehicle 12. A winch line 98 is coupled to and wound about the winch 96 and is coupled to the crossbar 56. The winch line 98 pulls the second ends 54 of the pair of lift arms 50 in a lifting direction 104 when the winch 96 is rotated in a first direction 100. The winch line 98 is configured for lifting the spray deck 58 away from the support surface 48 when the winch 96 is rotated in the first direction 100. The winch line 98 facilitates a gravitational force moving the second ends 54 of the pair of lift arms 50 in a deployment direction 106 when the winch 96 is rotated in a second direction 102 opposite the first direction 100, the deployment direction 106 being opposite the lifting direction 104. The winch line 98 is configured for deploying the spray deck 58 onto the support surface 48 when the winch 96 is rotated in the second direction 102.

A fluid supply line 108 is coupled to the body 14 of the vehicle 12 and is configured for receiving a flow of a fluid from a pressure washer 110. A fluid supply valve 112 is operationally coupled to the fluid supply line 108 which is configured for permitting the flow of the fluid to travel through the fluid supply line 108 when the fluid supply valve 112 is open and for preventing the flow of the fluid from traveling through the fluid supply line 108 when the fluid supply valve 112 is closed. Each of a plurality of fluid branch lines 114 is in fluid communication with the fluid supply line 108 and is configured for selectively receiving the flow of the fluid from the fluid supply line 108. The plurality of fluid branch lines 114 includes a pair of spray arm branch lines 116 and a manifold 132 branch line 118. Each of a plurality of fluid branch valves 120 is operationally coupled to a respective fluid branch line. Each fluid branch valve 120 is configured for permitting the flow of the fluid to travel through the respective fluid branch line when each fluid branch valve 120 is open and for preventing the flow of the fluid from traveling through the respective fluid branch line when each fluid branch valve 120 is closed.

Each of a pair of spray arms 122 is rotatably coupled to the top wall 60 of the spray deck 58 via an associated spindle 124. Each spray arm 122 is positioned within the perimeter wall 62 of the spray deck 58 and is rotatable about the associated spindle 124, each associated spindle 124 being perpendicular to the top wall 60. Each spray arm 122 is in fluid communication with a respective spray arm branch line 116 of the plurality of fluid branch lines 114. Each spray arm 122 has a pair of ends 126 with a pair of spray arm nozzles 128 positioned proximate an associated end 126 of each spray arm 122. Each pair of spray arm nozzles 128 of each spray arm 122 faces away from the top wall 60 and opposite a respective rotational direction 130 of a pair of rotational directions 130 of the pair of spray arms 122. Each spray arm 122 is configured for selectively receiving the flow of the fluid from the respective spray arm branch line 116 and dispensing the flow of the fluid through each spray arm nozzle 128, thereby forcibly removing a debris from the support surface 48 and propelling each spray arm 122 to rotate about the associated spindle 124 in the respective rotational direction 130.

A manifold 132 is coupled to the outer surface 72 of the perimeter wall 62 of the spray deck 58 between the rim end 64 of the perimeter wall 62 and the second edge 82 of the top wall 60 of the spray deck 58. The manifold 132 has a set of four manifold nozzles 134 facing away from the perimeter wall 62 and the top wall 60. The manifold 132 is in fluid communication with the manifold 132 branch line 118 of the plurality of fluid branch lines 114 and is configured for selectively receiving the flow of the fluid from the manifold 132 branch line 118 and dispensing the flow of the fluid through each manifold nozzle 134, thereby forcibly removing the debris from the support surface 48.

In use, a user operates the vehicle 12 while sitting in the chair 20. The vehicle 12 may be operated with the spray deck 58 is lifted away from the support surface 48, thereby facilitating the maneuvering and storage of the vehicle 12 in smaller spaces than when the spray deck 58 is in the spraying position 84. To deploy the spray deck 58 in the spraying position 84, the user rotates the winch 96 in the second direction 102, thereby facilitating a gravitational force urging the second ends 54 of the pair of lift arms 50 in the deployment direction 106 and deploying the spray deck 58 onto the support surface 48.

The user may then clean the support surface 48 using the spray arms 122 by opening the fluid supply valve 112 and the pair of fluid branch valves 120 coupled to the pair of spray arm branch lines 116, thereby facilitating the pressure washer 110 to supply each nozzle on each spray arm 122 with the flow of the fluid, propelling each spray arm 122 in its respective rotational direction 130, and forcibly removing the debris from the support surface 48. To clean or rinse the support surface 48 using the manifold nozzles 134, the user closes the fluid branch valves 120 coupled to the pair of spray arm branch lines 116 and opens the fluid branch valve 120 coupled to the manifold 132 branch line 118, thereby facilitating the pressure washer 110 to supply each manifold nozzle 134 with the flow of the fluid and forcibly removing debris from the support surface 48.

To lift the spray deck 58 away from the support surface 48, the user rotates the winch 96 in the first direction 100, thereby pulling the second ends 54 of the pair of lift arms 50 in the lifting direction 104 and lifting the spray deck 58 away from the support surface 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressure-washing vehicle device comprising:
a vehicle;
a lift arm, said lift arm having a first end and a second end, said first end of said lift arm being pivotably coupled to and extending forwardly from the vehicle, said lift arm being pivotable relative to said body such that an elevation of said second end relative to said vehicle is adjustable;
a spray deck, said spray deck having a top wall and a perimeter wall circumscribing and extending away from said top wall to a rim end of said perimeter wall, said top wall having an outer surface facing away from said perimeter wall and an inner surface opposing said outer surface of said top wall, said perimeter wall having an inner surface facing within said perimeter wall and an outer surface opposing said inner surface of said perimeter wall, said spray deck being coupled to said second end of said lift arm, said spray deck being configured to be positionable in a spraying position wherein said perimeter wall is positioned between said top wall and the support surface;
a spray arm, said spray arm being rotatably coupled to said spray deck via a spindle, said spray arm being positioned within said perimeter wall of said spray deck, said spray arm being rotatable about said spindle, said spray arm being configured for being in fluid communication with a pressure washer,
said spray arm having a spray arm nozzle, said spray arm nozzle facing away from said top wall, said spray arm being configured for selectively receiving a flow of a fluid from the pressure washer and dispensing the flow of the fluid through said spray arm nozzle while rotating, thereby forcibly removing a debris from the support surface.

2. The device of claim 1, further comprising said lift arm being one of a pair of lift arms, each said lift arm having a first end and a second end, said first end of each said lift arm being pivotably coupled to said vehicle, each said lift arm being pivotable such that an elevation of said second end of each said pair of lift arms relative to said body of said vehicle is adjustable, said spray deck being coupled to said second end of each said lift arm.

3. The device of claim 1, further comprising said top wall being elongated between a pair of lateral ends, said top wall having a pair of lateral edges, each said lateral edge extending through an associated lateral end of said top wall, each said lateral edge having a pair of ends, each said lateral edge being arcuate, said top wall having a first edge and a second edge opposing said first edge, each of said first edge and said second edge extending between said pair of lateral edges and being parallel to a central longitudinal axis of said top wall, said first edge being closer to said vehicle than said second edge when said spray deck is in said spraying position.

4. The device of claim 1, further comprising a plurality of spray deck casters, said plurality of spray deck casters being coupled to said spray deck, said spray deck casters being configured for movably supporting said spray deck on the support surface when said spray deck is in said spraying position.

5. The device of claim 3, further comprising a plurality of spray deck casters, said plurality of spray deck casters being coupled to said spray deck, said spray deck casters being configured for movably supporting said spray deck on the support surface when said spray deck is in said spraying position, each said spray deck caster including a caster bracket and a caster wheel, each said caster bracket having a first portion and a second portion, said first portion of each caster bracket being coupled to said outer surface of said top wall of said spray deck, said first portion of each caster bracket extending away from said outer surface of said perimeter wall perpendicular to said central longitudinal axis of said top wall, said second portion of each said caster bracket extending away from said inner surface of said top wall, each said caster wheel being coupled to an associated second portion of each said caster bracket, each said caster wheel being configured for movably supporting said spray deck on the support surface when said spray deck is in said spraying position.

6. The device of claim 5, further comprising each said spray deck caster being positioned such that said first portion of each caster bracket extends across an associated lateral edge of said top wall proximate a respective end of each said pair of ends of each said lateral edge, said plurality of spray deck casters being equidistant from a center of said top wall.

7. The device of claim 1, further comprising:
a winch, said winch being coupled to said vehicle; and
a winch line, said winch line being coupled to and wound about said winch, said winch line being coupled to said lift arm, said winch line pulling said second end of said lift arm in a lifting direction when said winch is rotated in a first direction, said winch line being configured for lifting said spray deck away from the support surface when said winch is rotated in said first direction, said winch line facilitating a gravitational force moving said second end of said lift arm in a deployment direction when said winch is rotated in a second direction opposite said first direction, said deployment direction being opposite said lifting direction, said winch line being configured for deploying said spray deck onto the support surface when said winch is rotated in said second direction.

8. The device of claim 1, further comprising:
a fluid supply line, said fluid supply line being coupled to said vehicle, said fluid supply line being configured for receiving the flow of the fluid from the pressure washer,
said spray arm being configured for selectively receiving a flow of a fluid from said fluid supply line and dispensing the flow of the fluid through said spray arm nozzle while rotating, thereby forcibly removing a debris from the support surface.

9. The device of claim 8, further comprising a fluid supply valve, said fluid supply valve being operationally coupled to said fluid supply line, said fluid supply valve being configured for permitting the flow of the fluid to travel through said fluid supply line when said fluid supply valve is open, said fluid supply valve being configured for preventing the flow of the fluid from traveling through said fluid supply line when said fluid supply valve is closed.

10. The device of claim 1, further comprising said spray arm having a pair of ends, said spray arm having a pair of spray arm nozzles, each said spray arm nozzle being positioned proximate an associated end of said spray arm, said pair of spray arm nozzles of each said spray arm facing away from said top wall and opposite a respective rotational direction of said spray arm, said spray arm being configured for selectively receiving the flow of the fluid from the pressure washer and dispensing the flow of the fluid through each said spray arm nozzle, thereby forcibly removing a debris from the support surface and propelling each said spray arm to rotate about said associated spindle in the respective rotational direction.

11. The device of claim 1, further comprising said spray arm being one of a pair of spray arms, each said spray arm being rotatably coupled to said top wall of said spray deck via an associated spindle, each said spray arm being positioned within said perimeter wall of said spray deck, each said spray arm being rotatable about said associated spindle, each said spray arm configured for being in fluid communication with the pressure washer,
each said spray arm having a pair of ends, each said spray arm having a pair of spray arm nozzles, each said spray arm nozzle being positioned proximate an associated end of each said spray arm, each said pair of spray arm nozzles of each said spray arm facing away from said top wall and opposite a respective rotational direction of a pair of rotational directions of said pair of spray arms, each said spray arm being configured for selectively receiving the flow of the fluid from the pressure washer and dispensing the flow of the fluid through each said spray arm nozzle, thereby forcibly removing a debris from the support surface and propelling each said spray arm to rotate about said associated spindle in the respective rotational direction.

12. The device of claim 11, further comprising:
a fluid supply line, said fluid supply line being coupled to said vehicle, said fluid supply line being configured for receiving a flow of a fluid from the pressure washer; and
a plurality of fluid branch lines, each said fluid branch line being in fluid communication with said fluid supply line, each said fluid branch line being configured for selectively receiving the flow of the fluid from said fluid supply line, said plurality of fluid branch lines including a pair of spray arm branch lines,
each said spray arm being in fluid communication with a respective spray arm branch line of said plurality of fluid branch lines, each said spray arm being configured for selectively receiving the flow of the fluid from said respective spray arm branch line.

13. The device of claim 12, further comprising:
a fluid supply valve, said fluid supply valve being operationally coupled to said fluid supply line, said fluid supply valve being configured for permitting the flow of the fluid to travel through said fluid supply line when said fluid supply valve is open, said fluid supply valve being configured for preventing the flow of the fluid from traveling through said fluid supply line when said fluid supply valve is closed; and
a plurality of fluid branch valves, each said fluid branch valve being operationally coupled to a respective fluid branch line, each said fluid branch valve being configured for permitting the flow of the fluid to travel through said respective fluid branch line when each said fluid branch valve is open, each said fluid branch valve being configured for preventing the flow of the fluid from traveling through said respective fluid branch line when each said fluid branch valve is closed.

14. The device of claim 1, further comprising a manifold, said manifold being coupled to said spray deck, said manifold having a manifold nozzle facing away from said spray deck and said vehicle, said manifold being configured for being in fluid communication with the pressure washer, said manifold being configured for selectively receiving the flow of the fluid from said manifold branch line and dispensing the flow of the fluid through each said manifold nozzle, thereby forcibly removing the debris from the support surface.

15. The device of claim 14, further comprising said manifold nozzle being one of a plurality of manifold nozzles, each said manifold nozzle facing away from said spray deck and said vehicle, said manifold being configured for selectively dispensing the flow of the fluid through said plurality of manifold nozzles, thereby forcibly removing the debris from the support surface.

16. The device of claim 11, further comprising a manifold, said manifold being coupled to said spray deck, said manifold having a manifold nozzle facing away from said spray deck and said vehicle, said manifold being configured for being in fluid communication with the pressure washer, said manifold being configured for selectively receiving the flow of the fluid from said manifold branch line and dispensing the flow of the fluid through each said manifold nozzle, thereby forcibly removing the debris from the support surface.

17. The device of claim 16, further comprising:
a fluid supply line, said fluid supply line being coupled to said vehicle, said fluid supply line being configured for receiving a flow of a fluid from the pressure washer; and
a plurality of fluid branch lines, each said fluid branch line being in fluid communication with said fluid supply line, each said fluid branch line being configured for selectively receiving the flow of the fluid from said fluid supply line, said plurality of fluid branch lines including a pair of spray arm branch lines and a manifold branch line,
each said spray arm being in fluid communication with a respective spray arm branch line of said plurality of fluid branch lines, each said spray arm being configured for selectively receiving the flow of the fluid from said respective spray arm branch line,
said manifold being in fluid communication with said manifold branch line, said manifold being configured for selectively receiving the flow of the fluid from the manifold branch line.

18. The device of claim 17, further comprising:
a fluid supply valve, said fluid supply valve being operationally coupled to said fluid supply line, said fluid supply valve being configured for permitting the flow of the fluid to travel through said fluid supply line when said fluid supply valve is open, said fluid supply valve being configured for preventing the flow of the fluid from traveling through said fluid supply line when said fluid supply valve is closed; and
a plurality of fluid branch valves, each said fluid branch valve being operationally coupled to a respective fluid branch line, each said fluid branch valve being configured for permitting the flow of the fluid to travel through said respective fluid branch line when each said fluid branch valve is open, each said fluid branch valve being configured for preventing the flow of the fluid from traveling through said respective fluid branch line when each said fluid branch valve is closed.

19. The device of claim 1, further comprising said vehicle having a body, a pair of drive wheels, a pair of casters, a chair, and a roll bar,
said body having a front end and a back end, said body having a pair of lateral sides extending between said front end of said body and said back end of said body, said body having a bottom side extending between said front end of said body and said back end of said body and between said lateral sides of said body,
said body having a front section adjacent to said front end of said body, said body having a back section adjacent to said back end of said body, said body having a platform section between said front section and said back section,
said back section having a top surface and a front surface, said top surface of said back section opposing said bottom side of said body, said front surface of said back section being convex and extending from said platform section to said top surface of said back section, said platform section having a top surface, said top surface of said platform section opposing said bottom side of said body, said platform section having a height between said top surface of said platform section and said bottom side of said body less than a height of said back section between said top surface of said back section and said bottom side of said body, said front section having a top surface, said top surface of said front section opposing said bottom side of said body, said front section having a height between said top surface of said front section and said bottom side of said body greater than said height of said platform section and less than said height of said back section, said front section having a back surface, said back surface extending from said top surface of said front section to said platform section,
said pair of drive wheels being rotationally coupled to said body, said pair of drive wheels being rotatable about a drive axis, said drive axis being positioned away from said bottom side of said body, said drive axis being perpendicular to each said lateral side of said body, each said drive wheel being positioned proximate an associated lateral side of said body, said pair of drive wheels being configured for moving said vehicle over a support surface,
said pair of casters being coupled to said front section of said body on said lateral sides of said body, said pair of casters extending away from said bottom side of said body, said pair of casters being configured for supporting said vehicle on the support surface,
said chair being positioned proximate said top surface of said back section of said body and said front surface of said back section of said body, said chair facing toward said front end of said body,
said roll bar being coupled to said top surface of said back section of said body proximate said chair, said roll bar arcing away from said body between said lateral sides of said body.

20. A pressure-washing vehicle device comprising:
a vehicle, said vehicle having a body, a pair of drive wheels, a pair of casters, a chair, and a roll bar,
said body having a front end and a back end, said body having a pair of lateral sides extending between said front end of said body and said back end of said body, said body having a bottom side extending between said front end of said body and said back end of said body and between said lateral sides of said body,
said body having a front section adjacent to said front end of said body, said body having a back section adjacent to said back end of said body, said body having a platform section between said front section and said back section,
said back section having a top surface and a front surface, said top surface of said back section opposing said bottom side of said body, said front surface of said back section being convex and extending from said platform section to said top surface of said back section, said platform section having a top surface, said top surface of said platform section opposing said bottom side of said body, said platform section having a height between said top surface of said platform section and said bottom side of said body less than a height of said back section between said top surface of said back section and said bottom side of said body, said front section having a top surface, said top surface of said front section opposing said bottom side of said body, said front section having a height between said top surface of said front section and said bottom side of said body greater than said height of said platform section and less than said height of said back section, said front section having a back surface, said back surface extending from said top surface of said front section to said platform section,
said pair of drive wheels being rotationally coupled to said body, said pair of drive wheels being rotatable about a drive axis, said drive axis being positioned away from said bottom side of said body, said drive axis being perpendicular to each said lateral side of said body, each said drive wheel being positioned proximate an associated lateral side of said body, said pair of drive wheels being configured for moving said vehicle over a support surface,
said pair of casters being coupled to said front section of said body on said lateral sides of said body, said pair of casters extending away from said bottom side of said body, said pair of casters being configured for supporting said vehicle on the support surface,
said chair being positioned proximate said top surface of said back section of said body and said front surface of said back section of said body, said chair facing toward said front end of said body,
said roll bar being coupled to said top surface of said back section of said body proximate said chair, said roll bar arcing away from said body between said lateral sides of said body;
a pair of lift arms, each said lift arm having a first end and a second end, said first end of each said lift arm being pivotably coupled to said front end of said body of said vehicle, each said lift arm being pivotable such that an elevation of said second end of each said pair of lift arms relative to said body of said vehicle is adjustable;
a crossbar, said crossbar extending between and coupling said pair of lift arms proximate each said second end of each said lift arm;
a spray deck, said spray deck having a top wall and a perimeter wall circumscribing and extending away from said top wall to a rim end of said perimeter wall, said top wall having an outer surface facing away from said perimeter wall and an inner surface opposing said outer surface of said top wall, said perimeter wall having an inner surface facing within said perimeter wall and an outer surface opposing said inner surface of said perimeter wall,
said top wall being elongated between a pair of lateral ends, said top wall having a pair of lateral edges, each said lateral edge extending through an associated lateral end of said top wall, each said lateral edge having a pair of ends, each said lateral edge being arcuate, said top wall having a first edge and a second edge opposing said first edge, each of said first edge and said second edge extending between said pair of lateral edges and being parallel to a central longitudinal axis of said top wall,
said outer surface of said top wall being pivotably coupled to said second end of each said lift arm, said second ends of said pair of lift arms being aligned with a central longitudinal axis of said top wall,
said spray deck being configured to be positionable in a spraying position wherein said perimeter wall is positioned between said top wall and the support surface and said first edge is closer to said vehicle than said second edge;
a plurality of spray deck casters, said plurality of spray deck casters being coupled to said spray deck, said spray deck casters being configured for movably supporting said spray deck on the support surface when said spray deck is in said spraying position,
each said spray deck caster including a caster bracket and a caster wheel, each said caster bracket having a first portion and a second portion, said first portion of each caster bracket being coupled to said outer surface of said top wall of said spray deck, said first portion of each caster bracket extending away from said outer surface of said perimeter wall perpendicular to said central longitudinal axis of said top wall, said second portion of each said caster bracket extending away from said inner surface of said top wall, each said caster wheel being coupled to an associated second portion of each said caster bracket, each said caster wheel being configured for movably supporting said spray deck on the support surface when said spray deck is in said spraying position,
each said spray deck caster being positioned such that said first portion of each caster bracket extends across an associated lateral edge of said top wall proximate a respective end of each said pair of ends of each said lateral edge, said plurality of spray deck casters being equidistant from a center of said top wall;
a winch, said winch being coupled to said back surface of said front section of said body of said vehicle;
a winch line, said winch line being coupled to and wound about said winch, said winch line being coupled to said crossbar, said winch line pulling said second ends of said pair of lift arms in a lifting direction when said winch is rotated in a first direction, said winch line being configured for lifting said spray deck away from the support surface when said winch is rotated in said first direction, said winch line facilitating a gravitational force moving said second ends of said pair of lift arms in a deployment direction when said winch is rotated in a second direction opposite said first direction, said deployment direction being opposite said lifting direction, said winch line being configured for deploying said spray deck onto the support surface when said winch is rotated in said second direction;
a fluid supply line, said fluid supply line being coupled to said body of said vehicle, said fluid supply line being configured for receiving a flow of a fluid from a pressure washer;
a fluid supply valve, said fluid supply valve being operationally coupled to said fluid supply line, said fluid supply valve being configured for permitting the flow of the fluid to travel through said fluid supply line when said fluid supply valve is open, said fluid supply valve being configured for preventing the flow of the fluid from traveling through said fluid supply line when said fluid supply valve is closed;
a plurality of fluid branch lines, each said fluid branch line being in fluid communication with said fluid supply line, each said fluid branch line being configured for selectively receiving the flow of the fluid from said fluid supply line, said plurality of fluid branch lines including a pair of spray arm branch lines and a manifold branch line;
a plurality of fluid branch valves, each said fluid branch valve being operationally coupled to a respective fluid branch line, each said fluid branch valve being configured for permitting the flow of the fluid to travel through said respective fluid branch line when each said fluid branch valve is open, each said fluid branch valve being configured for preventing the flow of the fluid from traveling through said respective fluid branch line when each said fluid branch valve is closed;
a pair of spray arms, each said spray arm being rotatably coupled to said top wall of said spray deck via an associated spindle, each said spray arm being positioned within said perimeter wall of said spray deck, each said spray arm being rotatable about said associated spindle, each said associated spindle being perpendicular to said top wall, each said spray arm being in fluid communication with a respective spray arm branch line of said plurality of fluid branch lines,
each said spray arm having a pair of ends, each said spray arm having a pair of spray arm nozzles, each said spray arm nozzle being positioned proximate an associated end of each said spray arm, each said pair of spray arm nozzles of each said spray arm facing away from said top wall and opposite a respective rotational direction of a pair of rotational directions of said pair of spray arms, each said spray arm being configured for selectively receiving the flow of the fluid from said respective spray arm branch line and dispensing the flow of the fluid through each said spray arm nozzle, thereby forcibly removing a debris from the support surface and propelling each said spray arm to rotate about said associated spindle in the respective rotational direction; and
a manifold, said manifold being coupled to said outer surface of said perimeter wall of said spray deck between said rim end of said perimeter wall and said second edge of said top wall of said spray deck, said manifold having a set of four manifold nozzles facing away from said perimeter wall and said top wall, said manifold being in fluid communication with said manifold branch line of said plurality of fluid branch lines, said manifold being configured for selectively receiving the flow of the fluid from said manifold branch line and dispensing the flow of the fluid through each said manifold nozzle, thereby forcibly removing the debris from the support surface.
